(19) United States
(12) Patent Application Publication
(10) Pub. No.: US 2010/0163624 A1
(43) Pub. Date: Jul. 1, 2010

(54) Bar Code Scanner With Environmental Sensing

(75) Inventors: Kazukuni Hosoi, Saitama Pref. (JP); Tohru Takahashi, Saitama (JP)

Correspondence Address: Kaplan Gilman & Pergament LLP, 1480 Route 9 North, Woodbridge, NJ, 07095, US

(73) Assignees: Optoelectronics Co., Ltd., Warabi (JP); Opticon, Inc., Orangeburg, NY (US)

(21) Appl. No.: 12/615,716

(22) Filed: Nov. 10, 2009

Related U.S. Application Data
(63) Continuation of application No. PCT/US07/11824, filed on May 17, 2007.

(51) Int. Cl. G06K 7/10

(52) U.S. Cl. 235/462.3; 235/435

(57) ABSTRACT

A bar code scanner is disclosed which may include a scanner gun; and at least one sensor in communication with the scanner gun, wherein the at least one sensor is operable to detect at least one operating condition of the bar code scanner.

The present patent application is a continuation of International Application No. PCT/US2007/011824, filed May 17, 2007, which designated the United States of America and was published in English as WO2008/143612 on Nov. 27, 2008.

### BACKGROUND OF THE INVENTION

Bar code scanner systems are known. Existing bar code scanners typically conduct various functions on an ongoing basis, such as automatic focusing, image data acquisition, and image data decoding. Once powered on, conducting the above-listed operations unconditionally may help ensure that image data intended for capture is acquired once the bar code scanner is aimed at the pertinent image. However, continuously conducting the above-listed functions, whether needed or not, will waste energy, and may cause the bar code scanner to acquire, decode, and store data associated with extraneous images having no relation to the bar codes to be scanned. Such extraneous data may waste data storage space and may require that subsequent operations be conducted to separate the extraneous image data from the bar code data. Accordingly, it is a problem in the art that one or more bar code scanner operations are conducted unconditionally upon powering on the scanner, or alternatively, require a user input such as trigger activation to be conducted.

### SUMMARY OF THE INVENTION

According to one aspect, the present invention may provide a method for controlling a bar code scanner that may include detecting a condition of the bar code scanner; and changing at least one operation of the bar code scanner based on the detected condition.

According to another aspect, the invention may provide a bar code scanner that may include a scanner gun; and at least one sensor in communication with the scanner gun, wherein the at least one sensor is operable to detect at least one operating condition of the bar code scanner.

In a preferred embodiment, the scanner implements plural operations or stays in a desired mode when it is not being used, and implements different operations or goes into a different mode when it is being used. In accordance with an exemplary embodiment, the scanner starts and stops certain operations and/or changes mode when it is about to be used or when use is finished, based upon the scanner's ability to detect when use or end of use is about to occur.

Other aspects, features, advantages, etc. will become apparent to one skilled in the art when the description of the preferred embodiments of the invention herein is taken in conjunction with the accompanying drawings.

### BRIEF DESCRIPTION OF DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a schematic diagram of a bar code scanner in accordance with one or more embodiments of the present invention;

FIG. 2 is a flow chart of a sequence of steps that may be implemented by a bar code scanner in accordance with one or more embodiments of the present invention.

FIG. 3 is a schematic diagram of a bar code scanner in accordance with one or more embodiments of the present invention; and

FIG. 4 is a flow chart of an additional embodiment of the present invention.

### DETAILED DESCRIPTION OF THE PREFERRED EMBODIMENTS

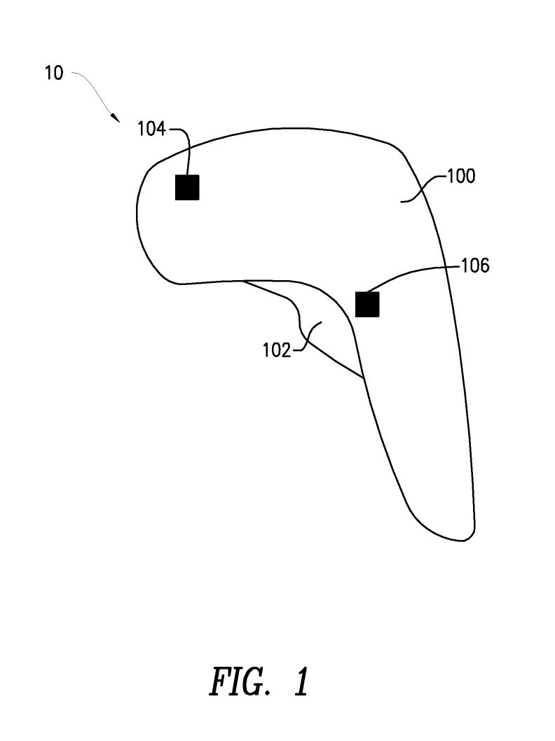

FIG. 1 is a schematic diagram of a bar code scanner 100 in accordance with one or more embodiments of the present invention. Bar code scanner 10 may include bar code scanner gun 100, trigger 102, motion sensor 104, and/or contact sensor 106. Bar code scanner gun 100 may be a conventional bar code scanner gun. Motion sensor (motion detector) 104 may be implemented using a gyroscope sensor, and/or other type of sensor.

Contact sensor 106 may be implemented using an Infra-Red (IR) sensor, a capacitance sensor, and/or other suitable sensor. Another type of sensor would be a light sensor positioned where the user's palm would cover, and arranged to sense the fact that light is no longer entering the sensing windows.

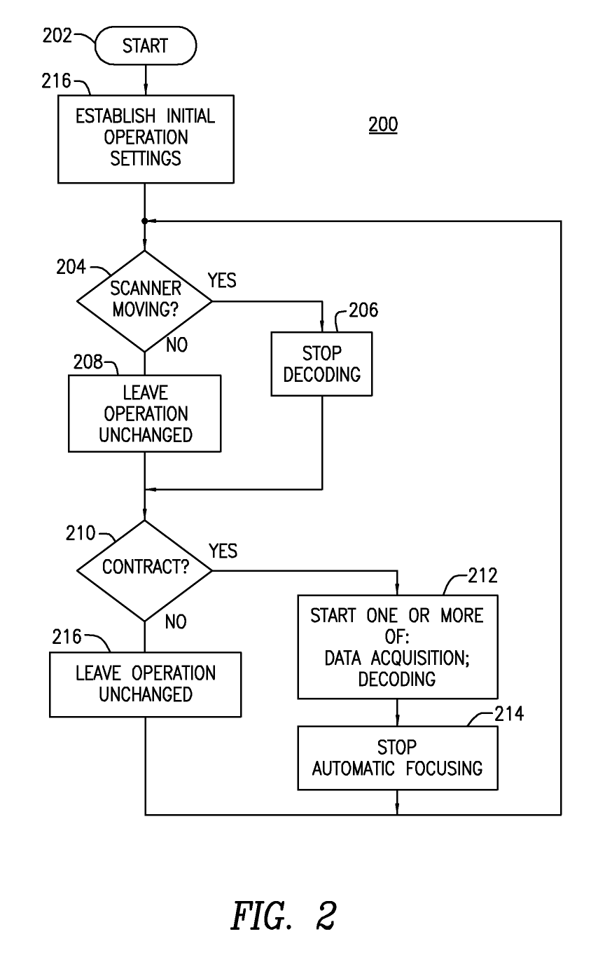

Motion sensor 104 may be operable to indicate whether bar code scanner 10 is moving or stationary. This information may be used in turn to start one or more bar code scanner 10 operations and/or stop one or more bar code scanner 10 operations. The use of information from motion sensor 104 is discussed in greater detail in connection with FIG. 2. In one or embodiments, motion sensor 104 could be located anywhere within bar code scanner gun 100. In one or more alternative embodiments, motion sensor 104 could be located outside scanner gun 100 but be placed in communication with scanner gun 100.

Contact sensor 106 may be operable to indicate whether an operator is contacting bar code scanner 10. Contacting bar code scanner 10 may include holding or merely touching the bar code scanner 10. Alternatively, contact sensor 106 could be configured to detect proximity of an operator to scanner 10 rather than actual physical touching of the scanner 10. This contact information may be used in turn to start one or more bar code scanner 10 operations and/or stop one or more bar code scanner 10 operations. The use of information from motion sensor 104 is discussed in greater detail in connection with FIG. 2.

In one or more embodiments, contact sensor 106 may be located in a region of the outside surface of scanner gun 100 that would be touched by an operator upon the operator's picking up scanner gun 100. In one or more alternative embodiments, contact sensor 106 may be placed in an interior portion of scanner gun 100 and employ a suitable sensing technology to determine when an operator is in contact with scanner gun 100.

It is also contemplated that plural sensors that detect a particular condition may be duplicated at various parts around the sensor to account for a left or right handed person. For example, a light detector that detects when a user's hand covers the portion held by the user may be implemented as two detectors, one on each side of the device, so that light is blocked from one of them regardless of whether a left or right handed person is handling the device.

FIG. 2 is a flow chart of a sequence of steps that may be implemented by a bar code scanner in accordance with one or more embodiments of the present invention. The method of FIG. 2 may be employed to control one or more operations of the bar code scanner 10 based on the detection of one or more conditions of the bar code scanner 10. Herein, the term “condition” generally corresponds to the term “operating condition”. Herein, controlling an operation of bar code scanner 10 may include turning on and/or turning off the operation, such as scanning, warming up for scanning, operating light emitters, activating sensors, changing modes, etc.

In one or more embodiments, the method 200 may start at step 202. At step 216, initial operation settings of bar code scanner 10 may be established. The initial settings may include placing the scanner in a sleep mode, deactivating or putting one or more components in a power save mode, or similar items.

At step 204, motion sensor 104 may indicate whether bar code scanner 10 is moving or not. If bar code scanner 10 is not moving, the operation of bar code scanner 10 may be left unchanged at step 208. If bar code scanner 10 is moving, one or more operations, such as decoding, may be stopped at step 206. The blocks 210 and 226, when combined with 204 or 208, cause the system to remain in a sleep or idle mode, for example, unless the device is moved or touched.

At step 210, it may be determined whether an operator is contacting bar code scanner 210, which may be accomplished using contact sensor 106. If bar code scanner 10 is not being contacted, the operation of bar code scanner 216 may be left unchanged at step 216. If contact with bar code scanner 10 is detected, one or more operations of bar code scanner 10 may be started or stopped in steps 212 and 214, respectively. When contact with bar code scanner 10 is detected, one of more operations of bar code scanner 10 may be initiated (step 212), which operations may include, but are not limited to: data acquisition, image data decoding, changing modes, or any of the other functions discussed above or still other functions. Other operations, including but not limited to automatic focusing, may be stopped (step 214), upon detecting contact with bar code scanner 10.

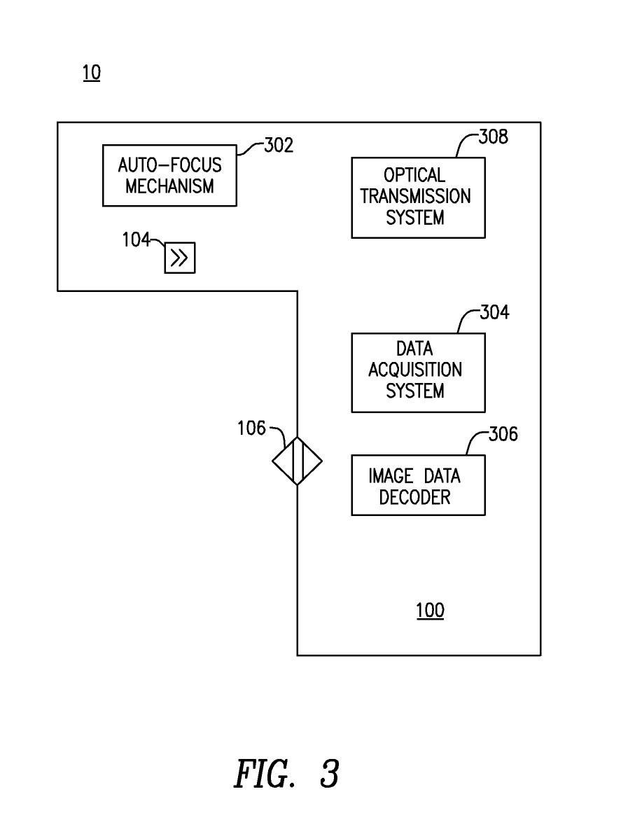

FIG. 3 is a schematic diagram of bar code scanner 10 in accordance with one or more embodiments of the present invention. FIG. 3 is provided to illustrate one or more features in addition to those shown in FIG. 1. Bar code scanner 10 may include bar code scanner gun 100, motion sensor 104, contact sensor 106, auto-focus mechanism 302, data acquisition system 304, image decoder system 306, and optical transmission system 308. Trigger 102 has been omitted in FIG. 3 for the sake of convenience. Motion sensor 104 and contact sensor 106 have been previously discussed herein. Accordingly, for the sake of convenience, that discussion is not repeated in this section.

In one or more embodiments, optical transmission system 308 may include optical components, electro-mechanical equipment, and control circuitry suitable for transmitting light to be reflected off a bar code, such as two-dimensional bar code. In one or more embodiments, auto-focus mechanism 302 may include lenses, motion equipment and control circuitry suitable for automatically focusing bar code scanner 10. In one or more embodiments, data acquisition system 304 may include optical devices, transduction equipment, and data processing circuitry suitable for receiving and at least temporarily storing image data received by bar code scanner 10. In one or more embodiments, image data decoder 306 may include data processing circuits suitable for converting image data received at bar code scanner 10 into bar code data originally incorporated into the bar codes read by bar code scanner 10.

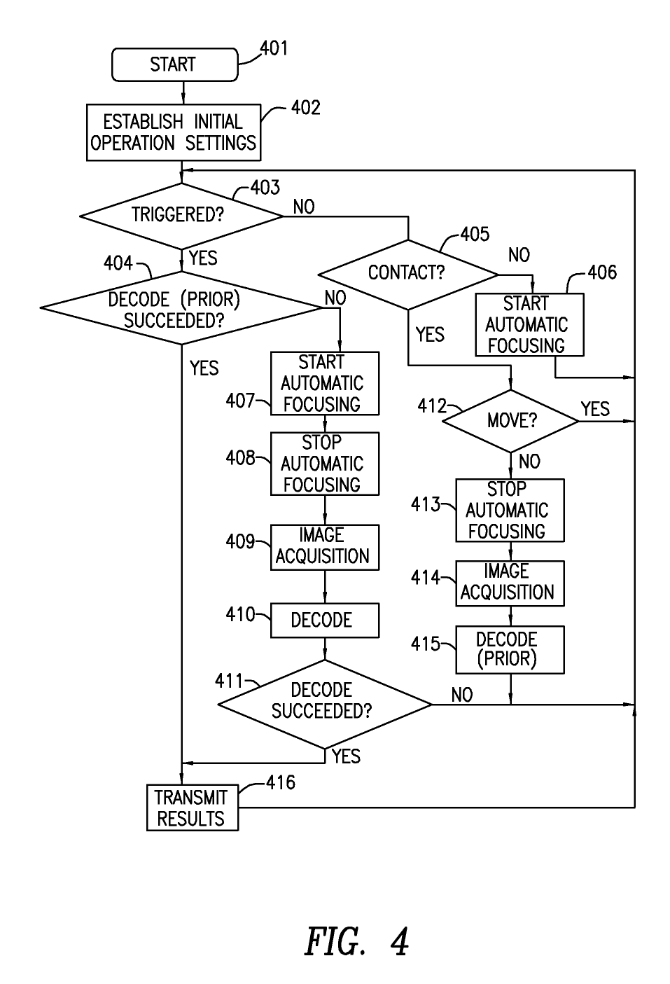

FIG. 4 describes an additional embodiment of the present invention which sets forth a sequence of step for facilitating automatic focusing, image acquisition, and decoding based upon the detection of motion and contact. The flow chart of FIG. 4 is by way of example only, and is not intended to imply a necessary order of steps, or any particular required implementation.

The system begins at block 401 where control is transferred to block 402 to establish the initial operation settings. With those initial settings in place, if the user depresses the trigger (sensed at block 403) then system attempts to decode the captured image. If successful, control is transferred to block 416, wherein the results are sent, for example, to a host computer system or other desired destination, and system then returns to the top of the flow chart as shown to await a next use of the scanner.

If the system is not triggered (a negative result at block 403) and is contacted by the user (a negative result at block 405), it is likely not being used by the operator, an automatic focus operation is initiated at block 406, in preparation for a future use. Control is then transferred to block 403 to test for a trigger.

If the system is not triggered (a negative result at block 403) but is contacted by the user, then a test at block 405 will transfer control to block 412 to test for movement, as shown. If this test indicates that there is movement, control reverts to block 403. When the tests at blocks 412 indicates that the scanner is not moved, this means that a user has likely picked it up for use and is aiming it at a target. As a result, blocks 413 through 415 stop the autofocus, acquire the image, and attempt to decode.

After the decode at block 415, the control will be returned to block 403 which is the test for triggering. Following the two alternative flow paths that emerge from block 404, it can be seen that after the scanner is triggered and the image captured and decoded by block 415, the system will then, as long as the trigger is held down, continue attempting to refocus and correctly decode the image at blocks 407-411 until a successful decode is achieved and the results transmitted at block 416. Essentially, the loop that comprises blocks 403-404, and 407-411 will continue to be executed repeatedly until a successful decode is achieved.

It is also notable that although the functions discussed herein are autofocus, image acquisition, and decoding, other functions may be implemented and automatically invoked and ceased based upon parameters measured via contact and/or motion.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for controlling a symbol reading device comprising:
detecting automatically whether the device is moving or stationary; and
if the device is moving, terminating at least one operation thereof related to reading a symbol.

2. A method for controlling a symbol reading device comprising:
detecting a condition of the device automatically, other than whether it is it is moving or whether a trigger is operated;
determining, in response to said detected condition, whether said device is about to be used or about to be completed being used, and
changing at least one operation of the device based on the detected condition to prepare the device for a subsequent operation.

3. The method of claim 2 wherein the step of detecting a condition of the device comprises determining whether an operator is in contact with the device.

4. The method of claim 2 wherein the changing step comprises starting a process of image acquisition by the bar code scanner if the detecting step indicates that the device is in contact with an operator.

5. The method of claim 2 wherein the changing step comprises starting decoding operation by the bar code scanner if the detecting step indicates that the bar code scanner is in contact with an operator.

6. The method of claim 2 wherein the changing step comprises starting automatically focusing the bar code scanner if the detecting step indicates that the bar code scanner is in contact with an operator.

7. Apparatus comprising:
a scanner for performing plural operations in connection with scanning and decoding symbols, and
at least one motion sensor in communication with the scanner, and
means for terminating at least one operation of the scanner related to scanning or decoding symbols in response to the sensor detecting that said scanner is in motion.

8. Apparatus comprising:
a scanner for performing plural operations in connection with scanning and decoding symbols, and
at least one sensor, other than a motion sensor or a trigger, in communication with the scanner, wherein the at least one sensor is operable to detect a user preparing to use or completing use of said scanner, and
a means for changing at least one operating parameter of the scanner in response to the sensor detecting said user preparing to use or completing use of the scanner.

9. The apparatus of claim 8 wherein the at least one sensor is a contact sensor.

10. The apparatus of claim 9 wherein the contact sensor is operable to indicate whether or not an operator is holding the apparatus.

11. The apparatus of claim 8 wherein said scanner changes from a dormant or sleep mode to an active mode in preparation of scanning if a motion sensor and a heat sensor are activated.

12. Apparatus of claim 11 wherein the scanner is gun shaped and the motion sensor is disposed on a forward portion of the gun, and a heat sensor on a rearward portion of said gun.

13. Apparatus of claim 11 wherein upon detecting a change in signals at said motion detector or said heat detector, said system goes into a power save mode.

14. Scanning apparatus for scanning and decoding a symbol, said apparatus comprising a plurality of sensors other than a trigger, each of said sensors detecting a different parameter, said scanning apparatus being configured to change from a power save mode to a use mode when at least two of said sensors detect their respective parameters, and from a use mode to a power save mode when at least one of said sensors changes state during or after said use.

15. The apparatus of claim 14 wherein said at least one of said sensors that changes state is one of said at least two said sensors.

16. The apparatus of claim 14 wherein said at least one of said sensors is not one of said at least two said sensors, but is one of said plurality of sensors.

17. A method of controlling an image capture device, said method comprising detecting whether the device is being contacted by a user and not moving, and if so, starting an automatic focus operation.

18. The method of claim 17 further comprising acquiring and decoding an image after said stopping.

19. The method of claim 18 further comprising the step of testing the device to determine if a user depressed a trigger, said testing being initiated in response to detecting that the device has been contacted by a user and is moving.
